(19) United States
(12) Patent Application Publication
(10) Pub. No.: US 2020/0361007 A1
(43) Pub. Date: Nov. 19, 2020

(54) METHOD OF MANUFACTURING CLAMPING JAWS, CLAMPING JAW AND DRILL CHUCK

(71) Applicant: Roehm GmbH, Sontheim/Brenz (DE)

(72) Inventors: Peter SCHENK, Niederstotzingen (DE); Hans BAUMANN, Sontheim-Brenz (DE); Stefan KEMPTER, Landensberg (DE)

(73) Assignee: Roehm GmbH, Sontheim/Brenz (DE)

(21) Appl. No.: 15/931,707

(22) Filed: May 14, 2020

(30) Foreign Application Priority Data
May 14, 2019 (DE) 10 2019 112 593.6

(51) Int. Cl. B23B 31/12

(52) U.S. Cl. CPC B23B 31/1215; B23B 2222/28

(57) ABSTRACT

A method of manufacturing clamping jaws for drill chucks, in which a pin is provided made from a blank, on which are formed a row of teeth furnished for engaging in a thread associated with the drill chuck and, axially offset on the side of the pin opposite the row of teeth, a clamping surface extending at an angle to the axis of the pin; in which at least one of the steps of quenching, carburizing, nitriding, and annealing is carried out to improve the material properties of the pin; and in which additional hardening is subsequently carried out in at least one region of the clamping jaws. The invention also relates to a clamping jaw and to a drill chuck having such clamping jaws.

This nonprovisional application claims priority under 35 U.S.C. § 119(a) to German Patent Application No. 10 2019 112 593.6, which was filed in Germany on May 14, 2019, and which is herein incorporated by reference.

### BACKGROUND OF THE INVENTION

### Field of the Invention

The present invention relates to a method of manufacturing clamping jaws for drill chucks, in which a pin is provided from a blank, in which a row of teeth furnished for engaging in a thread associated with the drill chuck and a clamping surface extending at an angle to the axis of the pin are formed on the side of the pin opposite the row of teeth and axially offset therefrom; in which at least one of the steps of quenching, carburizing, nitriding, and annealing is carried out to improve the material properties of the pin; and in which additional hardening is subsequently carried out in at least one region of the clamping jaws. The invention also relates to a clamping jaw and to a drill chuck.

### Description of the Background Art

It is crucial for safe drill operation that the clamping jaws securely hold the shank of the clamped workpiece or tool; this must be ensured over the entire service life of the drill chuck, and this service life should not be shortened as a result of the clamping surfaces being so deformed that they are no longer able to apply sufficient clamping force.

DE 100 08 262 A1, which corresponds to U.S. Pat. No. 6,427,555, which is herein incorporated by reference, discloses a method of manufacturing clamping jaws as well as clamping jaws made by that method, in which, in order to increase service life, the clamping surfaces, in particular clamping blades, are formed on hard-metal inserts, for which purpose a groove is formed in the clamping surface of the clamping jaw, in which the carbide inserts are inserted between two pairs of retaining bumps.

DE10 2004 006 804 A1 discloses a method of manufacturing hard-metal inserts as clamping jaws with clamping blades, in the manufacture of which, means are provided to prevent the hard-metal insert from being lifted perpendicular to the clamping surface, and in which, a binding material secures the carbide insert against displacement in the longitudinal direction of the clamping surface.

These clamping jaws with hard-metal inserts have been proven in practice, but it has been recognized as disadvantageous that their manufacture is complex and cost-intensive compared to manufacturing a steel jaw.

### SUMMARY OF THE INVENTION

It is therefore an object of the present invention to provide a method by which the manufacture of wear-resistant clamping jaws may be simplified. An additional object of the invention is to provide an improved clamping jaw as well as an improved drill chuck.

In an exemplary embodiment, the use of hard-metal inserts may be dispensed with and, starting from the given blank, it is machined in such a way that it has the desired properties, namely a high degree of toughness at least in the vicinity of the thread and also an elastic deformability in the cross-section of the pin, so that its hardness cannot be maximised overall. However, a high hardness is required in the vicinity of the clamping surfaces, which is generated targetedly in this region; in this respect it is preferred that at least one clamping bevel is formed in the clamping surface and laser hardening hardens the vicinity of the clamping bevel. This takes advantage of the fact that laser hardening may also be used to machine irregular, three-dimensional workpieces, so that it is also applicable to the clamping bevel. During laser hardening, the laser beam heats the clamping bevel to just below melting temperature, so that the carbon atoms in the metal lattice may change their position. As soon as the laser beam moves on, self-quenching occurs due to the high thermal conductivity of the pin, resulting in a very hard metal structure. Hardness depths of 0.1-1.5 mm may be achieved by the laser beam, so that the clamping bevel may be completely hardened.

Alternatively, there is also the possibility that a material harder than the material of the pin is applied to the clamping surface by a laser welding method for use as a clamping bevel; preferably, the harder material is applied to the clamping surface by a powder deposition welding process; in other words, without departing from the scope of the invention, a generative step may be used to provide a clamping jaw with the desired properties.

The powder for the powder deposition welding process can be formed from a hard metal, so that the advantages known from the hard-metal inserts are provided in an alternative way, i.e. by using hard metal in an alternative manner without needing to manufacture and place hard-metal inserts.

The powder to be applied by the powder deposition welding process can be a powder mixture containing at least two constituents with differing properties in terms of toughness and hardness after deposition. It is therefore possible to create correspondingly hard and at the same time tough material properties, which are provided, in a generative manufacturing step, in a layer welded onto the clamping jaw.

The clamping bevel may run parallel to the tool shank to be clamped, so that in particular the use of a percussion mechanism remains possible.

The blank can be provided by cutting to length a round bar of steel, preferably having a carbon content of more than 0.4%, in order to enable laser hardening. If the required carbon content is not present, the aforementioned carburizing step may be performed.

The clamping jaw provided for accomplishing the object can be formed of a steel cylindrical pin, which is formed with a row of teeth for engaging in a thread associated with a drill chuck and axially offset on the side opposite the row of teeth, with a clamping surface that, in the assembled state, runs parallel to the axis of the drill chuck, characterized in that a clamping bevel is provided as a single unit on the clamping surface and has a hardness greater than that of the cylindrical pin. A drill chuck, in which a plurality of such clamping jaws are arranged, is characterized by a high wear resistance of these components and by a cost-effective production.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, are not limitive of the present invention, and wherein the sole figure is a perspective view of a clamping jaw.

### DETAILED DESCRIPTION

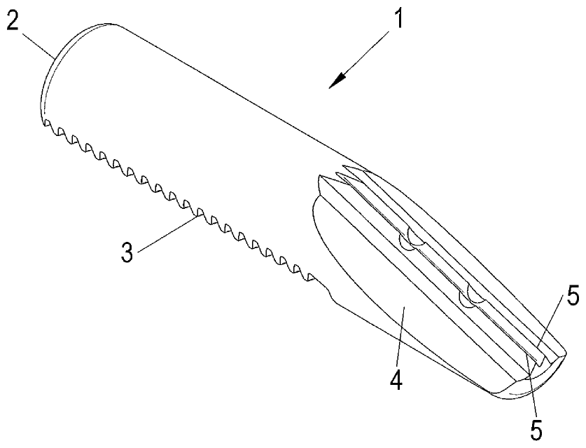

The FIG. 1 shows a clamping jaw 1 that is made from a blank obtained by cutting to length a round bar of steel; this steel has a carbon content of more than 0.4% or is imparted this carbon content by carburization. On the blank, which is formed by a cylindrical pin 2, a row of teeth 3 is formed, which is intended to engage in a thread associated with the drill chuck. Moreover, axially displaced on the side of the cylindrical pin 2 opposite the row of teeth 3, there is a clamping surface 4 that is inclined to the axis of the pin and on which, in the exemplary embodiment shown, two clamping bevels 5 are formed parallel to the tool shank that will be clamped.

In order to improve the material properties of the cylindrical pin 2, different steps may be carried out alternatively or cumulatively, namely the steps of quenching, carburizing, nitriding and tempering, so that the clamping jaw 1 obtains the desired properties, namely a high degree of toughness in the vicinity of the row of teeth 3 and a deformability in the elastic region of the base material.

On the clamping surface 4 of the parts of the clamping jaw 1 intended for contact with the tool or the workpiece, however, the greatest possible hardness is desired, so the clamping bevels are furnished with greater hardness than the cylindrical pin 2.

This is achieved by hardening the clamping bevel 5 or, in the exemplary embodiment shown, the two clamping bevels 5, by laser hardening. Alternatively, it is also possible that a material harder than the material of the cylindrical pin 2 is applied to the clamping surface 4 by a laser welding process for use as a clamping bevel 5, and may in particular be applied by a powder deposition welding process and the powder for the powder deposition welding process is formed from a hard metal or from a powder mixture by containing at least two constituents having properties that differ with regard to their toughness and hardness after being applied.

Such a clamping jaw 1 has at least the advantageous properties of a clamping jaw 1 furnished with hard-metal inserts, but may be manufactured at a much lower cost, so that the use of these clamping jaws 1 in a drill chuck retains its wear resistance.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed:

1. A method of manufacturing a clamping jaw for a drill chuck, the method comprising:
providing a pin from a blank;
forming a row of teeth furnished for engaging in a thread associated with the drill chuck; and
forming a clamping surface extending at an angle to an axis of the pin and on a side of the pin opposite the row of teeth and axially offset,
wherein at least one of the steps of quenching, carburizing, nitriding, or annealing is carried out to improve the material properties of the pin, and
wherein additional hardening is subsequently carried out in at least one region of the clamping jaws.

2. The method according to claim 1, wherein at least one clamping bevel is formed in the clamping surface, and wherein a vicinity of the clamping bevel is hardened by laser hardening.

3. The method according to claim 1, wherein a material harder than a material of the pin is applied to the clamping surface by a laser welding process, for use as a clamping bevel.

4. The method according to claim 3, wherein the harder material is applied to the clamping surface by a powder deposition welding process.

5. The method according to claim 4, wherein the powder for the powder deposition welding process comprises hard metal.

6. The method according to claim 4, wherein the powder to be applied by the powder deposition welding process is formed by a powder mixture containing at least two constituents with properties that differ in terms of toughness and hardness after deposition.

7. The method according to claim 2, wherein the clamping bevel is formed to run parallel to a tool shank that will be clamped.

8. The method according to claim 1, wherein the blank is provided by cutting to length a round bar of steel.

9. A clamping jaw comprising:
a steel cylindrical pin on which is formed a row of teeth for engaging in a thread associated with a drill chuck;
a clamping surface formed axially offset on a side opposite the row of teeth that, in the assembled state, runs parallel to an axis of a drill chuck; and
a clamping bevel formed as a single unit on the clamping surface with a hardness greater than that of the cylindrical pin.

10. A drill chuck comprising a plurality of clamping jaws according to claim 9.
